(19) United States
(12) Patent Application Publication
(10) Pub. No.: US 2006/0109935 A1
(43) Pub. Date: May 25, 2006

(54) Receiver system and method for soft-decision decoding of punctured convolutional codes in a wireless communication system

(75) Inventors: Neil McQueen, Plochingen (DE); Dirk Nikolai, Korntal-Münchingen (DE)

Correspondence Address: SUGHRUE MION, PLLC, 2100 PENNSYLVANIA AVENUE, N.W., SUITE 800, WASHINGTON, DC, 20037, US

(73) Assignee: EVOLIUM S.A.S.

(21) Appl. No.: 11/266,247

(22) Filed: Nov. 4, 2005

(30) Foreign Application Priority Data
Nov. 19, 2004 (EP) 04292746.7

(51) Int. Cl. H04L 27/06; H04B 14/04

(52) U.S. Cl. 375/340; 375/243

(57) ABSTRACT

A receiver system of a wireless communication system comprising means for receiving and decoding of punctured convolutional codes and characterized by comprising a soft-decision processing unit adapted to receive a number of quantized signal soft-decision values spread across a range, the range having a maximum value, a minimum value, and a value corresponding to the center of that range; shift a number of signal soft-decision values by a shift step away from said center value; and quantize the signal soft-decision values with fewer bits than the number used to quantize the received signal soft-decision values according to a determined quantization input-output relationship.

### BACKGROUND OF THE INVENTION

The invention is based on a priority application EP 04292746.7 which is hereby incorporated by reference.

The present invention relates to error correction coding in digital communication systems, and more particularly, to soft-decision decoding of punctured convolutional codes.

Forward error correction coding is a general technique of digital communication systems to protect the digital data from errors during transmission through a transmission channel. Data signals, in particular those transmitted over a radio transmission channel, are susceptible to errors caused by noise or interference. Error correction coding techniques enable a digital communication system to represent the data stream to be transmitted in a robust way so that the original data stream can be recovered at the receiver side even if it has been corrupted by the transmission channel.

One well-known error correction coding technique currently used in digital wireless communication systems is “punctured convolutional coding”. In general, communication systems using punctured convolutional coding basically comprise an encoding means for encoding a digital input to be transmitted from a transmitter and decoding means for decoding the coded input received at the receiver. The encoding means basically comprise a “convolutional coding circuit” which receives a digital input and outputs a convolutional encoded output, and, in order to increase the code rate of the encoder, the convolutionally encoded output is passed through a “puncturing circuit” which includes a transmission mask circuit and deleting pattern memory for transmitting only selected symbols of the convolutionally encoded output. At the receiver side, the decoding means basically comprise a “de-puncturing circuit” which, knowing the position of deleted symbols, re-inserts “dummy” symbols in the relative positions, and a “convolutional decoder circuit” typically using a Viterbi algorithm and referred to as “Viterbi decoder”.

Also, at the receiver side, generally a “soft-decision decoding” technique is used in order to improve the performance of the Viterbi decoder. Soft-decision decoding schemes at the receiver typically provide a better error correction capability than “hard decoding” schemes, which work only with two values or levels: “0” and “1”.

Soft-decision decoding quantizes a received signal into more than two state values or levels. For example, a soft-bit decision decoding method representing the received information, or soft-bits, in “5” quantization bits, gives rise to “2⁵=32” possible soft-decision values or levels depending on their “closeness” to either a logical “1” or “0”. These additional levels provide a measure of certainty or confidence that is associated with the received signal values.

An example of a method and apparatus using soft decision decoding of punctured convolutional codes is shown in Patent Publication No. WO 2004/056058. In said document, a UMTS/GSM receiver with EDGE services capability is disclosed in which a data sequence incorporating PSK symbols is separated into bits which are assigned confidence values and input to a convolutional decoder to provide improved decoding.

A problem with conventional systems for soft-decision decoding of punctured convolutional codes is that they tend to provide better bit error rate (BER) performance, i.e. a lower BER, at the expense of increasing the number of quantization bits or soft-decision values used to represent the received signal. As the number of quantization bits increases, the hardware or software complexity of the decoding means increases exponentially and the number of calculations required to do decoding increases such that it is no longer practical to do decoding this way. Also decoding the data requires an additional delay. This means that the receiver systems become more expensive due to increasing decoding equipment cost and processing power.

Thus, there is a need to find a compromise between the performance level of the decoding means and the complexity of its implementation in either hardware or software.

### SUMMARY OF THE INVENTION

It is the object of the invention to solve the aforesaid technical problems and provide an improved soft-decision decoding of data streams coded by means of punctured convolutional coding.

The object is achieved by
a method for soft-decision decoding of punctured convolutional codes comprising the steps of receiving a number of quantized signal soft-decision values spread across a range having a maximum value, a minimum value, and a value corresponding to the center of that range, shifting a number of signal soft-decision values by a shift step away from said center value, and quantizing the signal soft-decision values with fewer bits than the number used to quantize the received signal soft-decision values according to a determined quantization input-output relationship,
a receiver system of a wireless communication system comprising means for receiving and decoding of punctured convolutional codes and comprising a soft-decision processing unit adapted to receive a number of quantized signal soft-decision values spread across a range having a maximum value, a minimum value, and a value corresponding to the center of that range, shift a number of signal soft-decision values by a shift step away from said center value, and quantize the signal soft-decision values with fewer bits than the number used to quantize the received signal soft-decision values according to a determined quantization input-output relationship,
a base station and
a mobile station of a wireless communication system comprising said receiver system.

The method for soft-decision decoding of the invention maximizes the information available at the input of the soft-decision decoder using fewer quantization bits to represent the received soft-bits. The idea is then to reduce the computational complexity and enhance the decoding capability of the decoding means by using fewer quantization bits to represent the soft-decision values in the decoding process. In order to reduce the quantization bits and soft-decision values, a “coarse” quantization (quantization in fewer levels or with fewer quantization bits) of the received signal values is needed. The invention makes use of the observation that soft-decision zero values normally do not assist the decision making process in the decoder. The basic idea of the invention is then to differentiate between soft-decision values stemming from demodulation or equalization and soft-decision zero values—dummy symbols—inserted by the de-puncturer in order to save as much soft-decision information as possible when applying a coarse quantization to the received signal soft-decision values.

According to a first preferred embodiment of the invention, all received signal soft-decision values are shifted away from the zero value by one half of the coarse quantization step, and then the coarse quantization is applied to these values according to a certain coarse quantization input-output relationship.

According to a second preferred embodiment of the invention, the received signal soft-decision values that would fall into the soft-decision zero level of the coarse quantization are shifted away from the zero level by one half of the coarse quantization step, and then the coarse quantization is applied to these values according to a certain coarse quantization input-output relationship.

Advantageous configurations of the invention emerge from the dependent claims, the following description and the drawings. For example, the device and method of the invention achieve better BER performance for a given number of quantization bits used in the decoding process compared with conventional methods for soft-decision decoding of punctured convolutional codes using the same amount of quantization bits. Further it is seen advantageous that the present invention allows to reduce the complexity, cost, size and power consumption of the decoding means typically associated with prior art methods and apparatuses for soft-decision decoding of punctured convolutional codes, for a given BER performance. By applying the method of the invention, the number of quantization bits and soft-decision values needed to represent the received signal can be reduced while maintaining the performance of the decoding means.

### BRIEF DESCRIPTION OF THE DRAWINGS

An embodiment-simplified example of the invention is now explained with the aid of FIGS. 1 to 7.

FIG. 1 illustrates a block diagram of a wireless receiving system comprising soft-decision decoding means for punctured convolutional codes according to the invention.

FIG. 2 is a graph illustrating an exemplary histogram distribution of the soft bits at the output of an equalizer.

FIGS. 3A, B and C show by way of a histogram graph example a processing method of soft-decision values at a soft-decision processing unit according to a first embodiment of the invention.

FIG. 4 is a flow chart illustrating an operating process of a soft-decision processing unit according to a first embodiment of the invention.

FIGS. 5A and B show quantization tables for coarse quantization of the received signal soft-decision values according to the invention.

FIGS. 6A, B and C show by way of a histogram graph example a processing method of soft-decision values at a soft-decision processing unit according to a second embodiment of the invention.

FIG. 7 is a flow chart illustrating an operating process of a soft-decision processing unit according to a second embodiment of the invention.

### DETAILED DESCRIPTION OF THE DRAWINGS

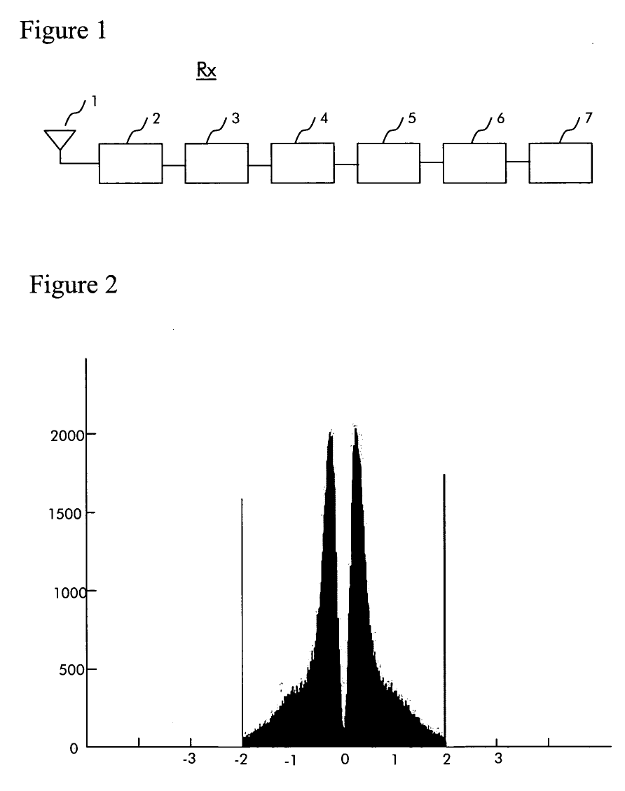

FIG. 1 shows a block diagram of an exemplary wireless receiving system Rx for receiving and decoding a transmitted signal which has been coded by punctured convolutional coding. Receiving system Rx comprises a receive antenna 1 that provides the received signals to a demodulator 2. The demodulator outputs a demodulated signal to an equalizer 3, which provides equalized soft-decision bit values to a soft-decision processing unit 4 according to the invention. The soft-decision processing unit 4 outputs soft-decision values to a de-puncturing circuit 5, where zero value indicatives are then inserted for punctured coded bits, and then the values are passed to a de-interleaving circuit 6 and convolutional decoder 7.

It is understood that the channel demodulation, de-puncturing, de-interleaving and decoding are complementary to the channel modulation interleaving, puncturing, and encoding performed at the corresponding transmitting system. The design of the receiving system Rx and the elements it comprises is typically dependent on the particular coding scheme used at the transmitter.

Representation of the symbols at the output of the demodulator 2 and/or equalizer 3 is done using multiple bits and it is referred to as “soft-decision data”, represented by a number “soft-decision values or levels”, depending on the number of quantization bits used to quantize the symbols. Soft-decision data is further processed at the soft-decision processing unit 4, de-puncturing circuit 5, de-interleaving circuit 6 and input to the decoder 7. The use of soft decision data can provide a better signal-to-noise ratio (SNR) performance at the same bit error level. This is because it contains information on the reliability of the received signal bits.

FIG. 2 is a graph illustrating an exemplary histogram distribution of the received signal soft-decision data at the output of a demodulator or an equalizer. It represents the number of received signal soft-decision levels (Y axis) spread between a range of “±2” (X Axis). The received signal soft-decision values greater or smaller than the “±2” range have been assigned to the positive limit “+2” and negative limit “−2” respectively. In the example of FIG. 2, “256” soft-decision levels are considered which correspond to a “8” bit quantization.

The histogram gives an appreciation of the population density of the received signal when two symbols “0”, “1” are transmitted. Usually, because of the influence of the transmission channel, the received symbol energy spreads out so that the energy from one symbol flows into, or interferes with, the other.

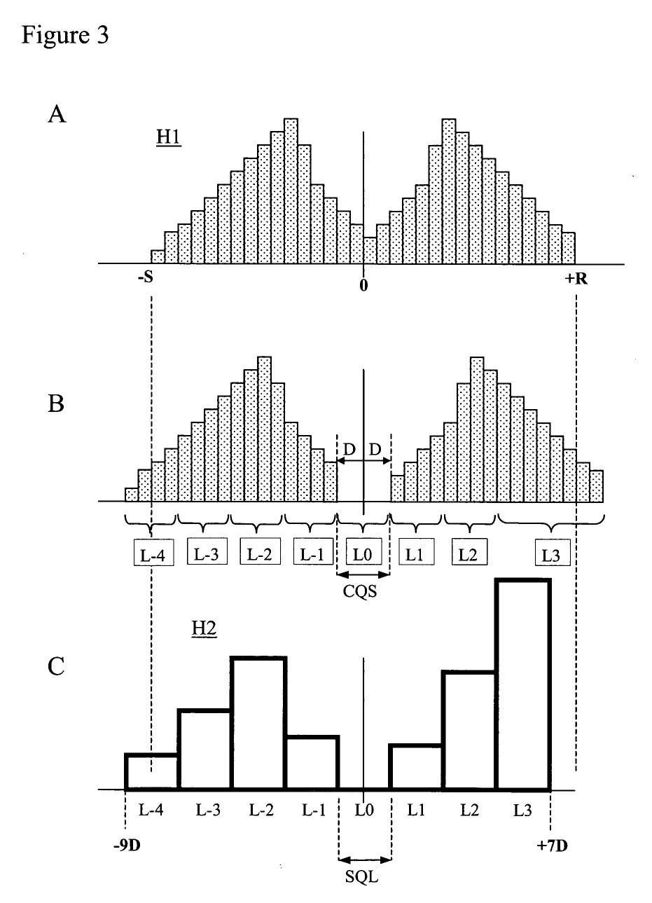

FIGS. 3A, B and C show by way of histogram H1, H2 graph example, a processing method of soft-decision values at the soft-decision processing unit 4 of FIG. 1 according to a first embodiment of the invention. The histogram H1 is the input to the soft-decision processing unit and the histogram H2 is the corresponding output after processing of the input soft-decision values according to the first embodiment of the invention.

In FIG. 3A, histogram H1 represents a number of received signal soft-decision values (Y axis) spread between a range −S to +R (X axis), at the input of the soft-decision processing unit. In the example of FIG. 3, “32” soft-decision values are considered which correspond to a “5” bit quantization.

According to a first preferred embodiment of the invention, the received signal “32” soft-decision values of FIG. 3A are shifted away from the zero value 0 by a shift step D, which is preferably one half of the coarse quantization step CQS applied to the received signal soft-decision values. In the example of FIG. 3, a “3” bit coarse quantization is applied to the “32” soft-decision values so that the histogram H2 of FIG. 3C, at the output of the soft-decision processing unit, is represented by, no longer “32” values, but “8” soft-decision values L-4 to L3.

In FIG. 3B we see how the input soft-decision values are shifted away from the zero value 0 by step D, positive values moving in the increasing positive X axis direction and negative values moving in the increasing negative X axis direction, this could be done for example by adding a shift step D to the soft-decision values greater than the zero value 0 and subtracting a shift step D to the soft-decision values smaller than the zero value 0. After that, a coarse “3” bit quantization in “8” soft-decision levels L-4 to L3 is applied.

As mentioned above, the shift step D is preferably one half of the coarse quantization step CQS applied and can generally be calculated by the equation

$$D = \frac{S}{{2}^{n}}$$

where “S” is the absolute value of the negative limit of the soft-decision value range −S to +R, and “n” is the number of the coarse quantization bits applied to the input soft-decision values. It shall be understood that other values of the shift step D around the preferred value can be applied to shift the input soft-decision values away from the zero value 0 depending on the decoding performance that wants to be achieved.

FIG. 3C shows an example of how the histogram H2 at the output of the soft-decision processing unit 4 would look like after processing of the input soft-decision values according to the first embodiment of the invention. As we can see, no zero soft-decision values LO are present at the output of the soft-decision processing unit.

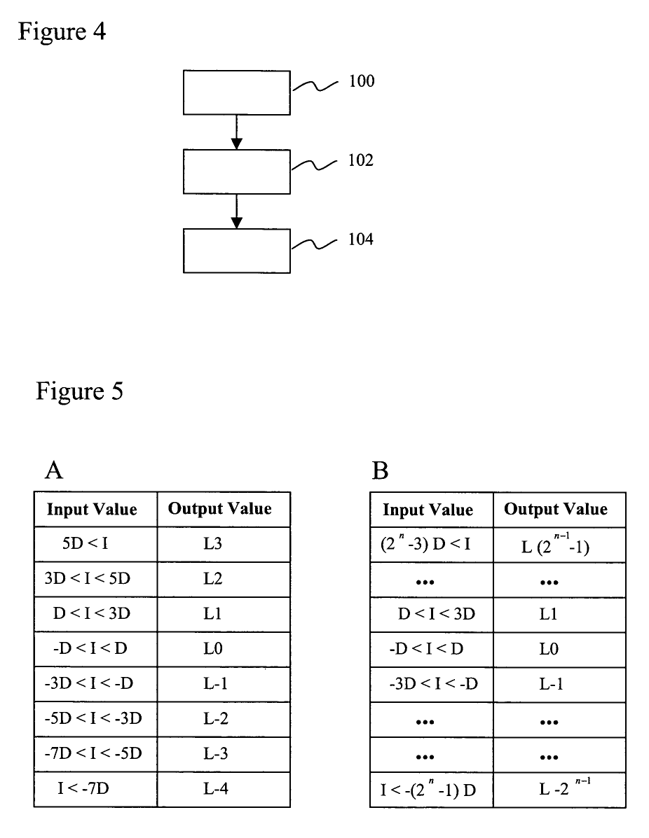

FIG. 4 is a flow chart illustrating an operating process of a soft-decision processing unit in charge of processing a plurality of input soft-decision values according to a first embodiment of the invention.

The soft-decision processing unit operates according to the invention as described in the example of FIG. 3. In a first step 100, the soft-decision processing unit receives the soft-decision values and in the subsequent step 102 it shifts said soft-decision values by a shift step away from the zero level. Finally, in a further step 104 the said shifted soft-decision values are quantized according to a certain quantization input-output relationship.

Preferably the quantization in step 104 is a coarse quantization, which means that fewer quantization bits and soft-decision values are used to represent the signal than the ones received. Better performances of the decoding means are achieved for example when the signal at the input of the soft-decision processing unit has at least a three bit higher quantization order than the quantization done in the soft-decision processing unit, e.g. “8” bit quantization at the input and “5” bit quantization at the output.

FIGS. 5A and B show quantization input-output relationship tables for quantization of soft-decision values at a soft-decision processing unit according to the invention.

FIG. 5A illustrates a “3” bit quantization input-output relationship in which a certain range of input values 1 are assigned to one of “8” soft-decision output values L-4 to L3. Soft-decision output value L0 corresponds to a zero signal value and soft-decision output values L-4 and L3 correspond to a most negative and most positive signal value respectively. A soft-decision output value L0 is applied to all input values in a rage between ±D, being D the shift step.

FIG. 5B illustrates a general rule for the calculation of a soft-bit quantization input-output relationship which is applied to the shifted soft-decision values according to the invention where n is the number of quantization bits used for the coarse quantization in the soft-decision processing unit and “D” is the shift step calculated above,

$$D = \frac{S}{{2}^{n}} .$$

It is understood that S is common to the input and the output of the soft-decision processing unit.

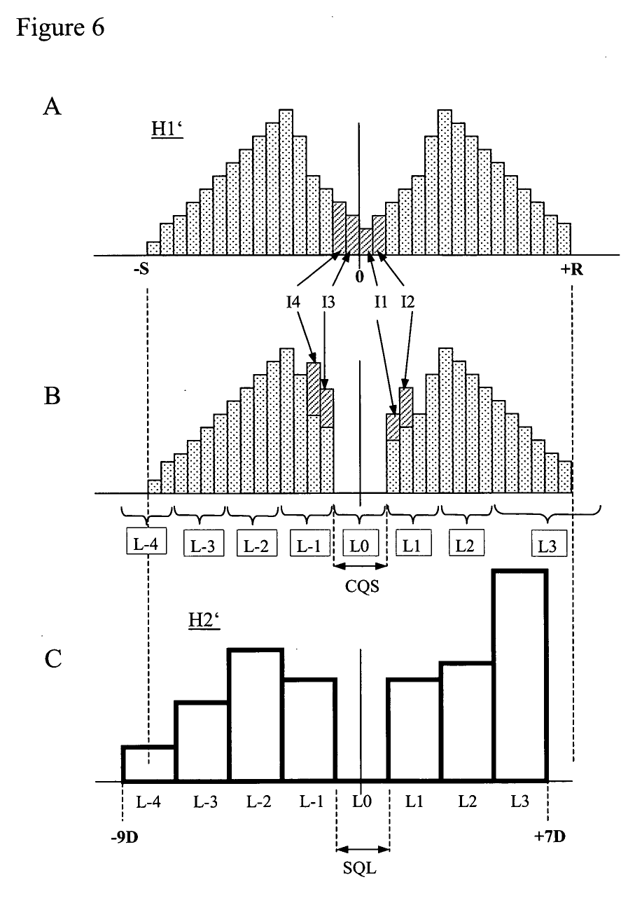

FIGS. 6A and B, C show by way of histogram H1′, H2′ graph example, a processing method of soft-decision values at the soft-decision processing unit 4 of FIG. 1 according to a second embodiment of the invention. The histogram H1 is the input to the soft-decision processing unit and the histogram H2 is the corresponding output after processing of the input soft-decision values according to the second embodiment of the invention.

In FIG. 6A, histogram H1′ represents a number of received signal soft-decision values (Y axis) spread between a range −S to +R (X axis), at the input of the soft-decision processing unit. In the example of FIG. 6, “32” soft-decision values are considered which correspond to a “5” bit quantization.

According to a second preferred embodiment of the invention, the received signal soft-decision values I1 to I4 of FIG. 6A that would fall into the zero value of the soft-decision processing unit coarse quantization are shifted away from the zero value 0 by a shift step D, which is preferably one half of the coarse quantization step CQS applied to the received signal soft-decision values. In the example of FIG. 6, a “3” bit coarse quantization is applied to the “32” soft-decision values so that the histogram H2′ of FIG. 6C, at the output of the soft-decision processing unit, is represented by “8” soft-decision values L-4 to L3.

In FIG. 6B we see how these input soft-decision values I1 to I4 are shifted away from the zero level 0 by step D, positive values I1 and I2 moving in the increasing positive X axis and negative values I3 and I4 moving in the increasing negative X axis. After that, a coarse “3” bit quantization in “8” soft-decision levels L-4 to L3 is applied.

As mentioned above, the shift step D is preferably one half of the coarse quantization step CQS applied and can generally be calculated by the equation

$$D = \frac{S}{{2}^{n}}$$

, where “S” is the absolute value of the negative limit of the soft-decision value range −S to +R, and “n” is the number of the coarse quantization bits applied to the input soft-decision values. It shall be understood that other values of the shift step D around the preferred value can be applied to shift the input soft-decision values away from the zero level 0 depending on the decoding performance that wants to be achieved.

FIG. 6C shows an example of how the histogram H2′ at the output of the soft-decision processing unit would look like after processing of the input soft-decision values according to the second embodiment of the invention. As we can see, no zero soft-decision values L0 are present at the output of the soft-decision processing unit.

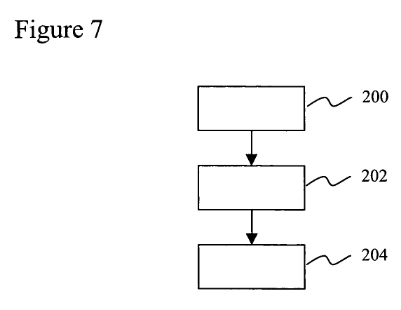

FIG. 7 is a flow chart illustrating an operating process of a soft-decision processing unit in charge of processing a plurality of input soft-decision values according to a second embodiment of the invention.

The soft-decision processing unit operates according to the invention as described in the example of FIG. 6. In a first step 200, the soft-decision processing unit receives the soft-decision values and in the subsequent step 202 it shifts a number of such input soft-decision values, preferably those that would fall into the zero value of the soft-decision processing unit coarse quantization, I1 to I4 of FIG. 6, away from the soft-decision zero value 0. Finally, in a further step 204 resulting soft-decision values are quantized according to a certain quantization input-output relationship.

Preferably the quantization in step 204 is a coarse quantization, which means that fewer quantization bits and soft-decision values are used to represent the signal than the ones received. Better performances of the decoding means are achieved for example when the signal at the input of the soft-decision processing unit has at least a three bit higher quantization order than the quantization done in the soft-decision processing unit, e.g. “8” bit quantization at the input and “5” bit quantization at the output.

Also, the coarse quantization input-output relationship applied at the soft-decision processing unit is calculated according to the general rule illustrated in FIG. 5B.

For the sake of generalization, it is understood that the method and device for soft-decision processing described herein can be implemented in any type of communication systems, such as software radio systems, high-definition television systems, etc. besides the already mentioned wireless communication systems as GSM, UMTS or the like. Further, the method and the device of the invention can be implemented in integrated circuits (ICs) such as application specific ICs (ASICs) or digital signal processors (DSPs), or in software form, within receivers, transceivers or the like. Finally, the soft-decision processing method may be employed at any convenient location within the data communication system.

1. Method for soft-decision decoding of punctured convolutional codes, comprising the steps of:
receiving a number of quantized signal soft-decision values spread across a range having a maximum value, a minimum value, and a value corresponding to the center of that range,
shifting a number of signal soft-decision values by a shift step away from said center value, and
quantizing the signal soft-decision values with fewer bits than the number used to quantize the received signal soft-decision values according to a determined quantization input-output relationship.

2. The method for soft-decision decoding of punctured convolutional codes of claim 1 wherein all received signal soft-decision values are shifted by a shift step away from the center value.

3. The method for soft-decision decoding of punctured convolutional codes of claim 1 wherein only those received signal soft-decision values which fall inside a negative to positive shift step range from the center value are shifted by a shift step.

4. The method for soft-decision decoding of punctured convolutional codes of claim 1 wherein the shift step is one half of the coarse quantization step applied to the signal soft-decision values after shifting.

5. The method for soft-decision decoding of punctured convolutional codes of claim 1 wherein the determined quantization input-output relationship is characterized by having a zero output soft-decision value corresponding to input soft-decision input values between a negative to positive shift step range.

6. The method for soft-decision decoding of punctured convolutional codes of claim 1 wherein said steps of the method are carried out after demodulation of the received signal and before de-puncturing of the signal soft-decision values.

7. A receiver system of a wireless communication system comprising means for receiving and decoding of punctured convolutional codes and characterized by comprising a soft-decision processing unit adapted to
receive a number of quantized signal soft-decision values spread across a range having a maximum value, a minimum value, and a value corresponding to the center of that range,
shift a number of signal soft-decision values by a shift step away from said center value, and
quantize the signal soft-decision values with fewer bits than the number used to quantize the received signal soft-decision values according to a determined quantization input-output relationship.

8. The receiver system of claim 7 in which the soft-decision processing unit is located after a demodulator and before a de-puncturing circuit.

9. A base station of a wireless communication system comprising a receiver system with means for receiving and decoding of punctured convolutional codes, the receiver system characterized by comprising a soft-decision processing unit adapted to
receive a number of quantized signal soft-decision values spread across a range having a maximum value, a minimum value, and a value corresponding to the center of that range,
shift a number of signal soft-decision values by a shift step away from said center value, and
quantize the signal soft-decision values with fewer bits than the number used to quantize the received signal soft-decision values according to a determined quantization input-output relationship.

10. A mobile station of a wireless communication system comprising a receiver system with means for receiving and decoding of punctured convolutional codes, the receiver system characterized by comprising a soft-decision processing unit adapted to
receive a number of quantized signal soft-decision values spread across a range having a maximum value, a minimum value, and a value corresponding to the center of that range,
shift a number of signal soft-decision values by a shift step away from said center value, and
quantize the signal soft-decision values with fewer bits than the number used to quantize the received signal soft-decision values according to a determined quantization input-output relationship.
